(19) United States
(12) Patent Application Publication
(10) Pub. No.: US 2025/0153282 A1
(43) Pub. Date: May 15, 2025

(54) WELDING WORKSTATION

(71) Applicant: CHENGDU XIONGGU JIASHI ELECTRICAL CO, LTD, Chengdu, Sichuan (CN)

(72) Inventors: Youjin XIAO, Chengdu, Sichuan (CN); Tan SHU, Chengdu, Sichuan (CN); Wang ZHANG, Chengdu, Sichuan (CN); Zonglei YU, Chengdu, Sichuan (CN); Jianglong HE, Chengdu, Sichuan (CN); Rongdong LI, Chengdu, Sichuan (CN); Biqing LIU, Chengdu, Sichuan (CN)

(73) Assignee: CHENGDU XIONGGU JIASHI ELECTRICAL CO, LTD, Chengdu, Sichuan (CN)

(21) Appl. No.: 18/836,545

(22) PCT Filed: Aug. 30, 2022
(86) PCT No.: PCT/CN2022/115753

§ 371 Date: Aug. 7, 2024

(30) Foreign Application Priority Data
Mar. 31, 2022 (CN) 202210331200.X

(51) Int. Cl. B23K 37/02; B23K 101/06

(52) U.S. Cl. CPC B23K 37/0229; B23K 37/0247; B23K 2101/06

(57) ABSTRACT

A welding workstation includes an integrated welding device. The integrated welding device includes a welding rail frame for enclosing the circumferential direction of a pipeline to be welded, a welding apparatus provided on the welding rail frame, a locomotive apparatus connected to the welding rail frame, and a girth weld driving apparatus connected to the welding rail frame or the welding apparatus; the locomotive apparatus is provided with driving wheels for roll-fitting pipeline to be welded or the ground, and the driving wheels moves along the axial direction of the pipeline to be welded; and the girth weld driving apparatus drives the welding apparatus to rotate around a seam to be welded of the pipeline to be welded. The welding workstation can realize automatic locomotion and automatic welding.

The present application claims the priority to Chinese patent application No. 202210331200.X, titled as “WELDING WORKSTATION”, filed with the Chinese State Intellectual Property Office on Mar. 31, 2022, the entire disclosure of which is incorporated herein by reference.

### FIELD

The present application relates to the field of pipeline welding, in particular to a welding workstation.

### BACKGROUND

At present, in the external welding operation for a pipeline, a traveling track is requested to be mounted manually and relevant welding equipment is hoisted to a specific position of the pipeline, and then the above welding equipment is assembled and manipulated by a welder to realize pre-welding preparation and complete the specific welding operation along the traveling track.

The above external welding operation needs a large number of manpower to complete a number of scattered processes step by step, such as mounting the traveling track, hoisting the welding equipment and mounting a welding trolley. Generally, many people are requested to drag the assembly of much welding equipment for re-aligning or to re-hoist and assemble the relevant welding equipment if multiple positions of the pipeline are welded, which is time-consuming, laborious, inefficient and difficult to control the construction quality.

In summary, how to improve the pipeline external welding operation has become an urgent problem for those skilled in the art.

### SUMMARY

A welding workstation is provided according to the present application, which can improve the process quality and process efficiency and reduce the operation burden of an operator.

The welding workstation includes a welding container, and the welding container includes:
a welding rail frame configured to surround along a circumferential direction of a to-be-welded pipeline;
a welding device arranged on the welding rail frame;
a traveling device connected to the welding rail frame, in which the traveling device includes multiple driving wheels for rolling against the to-be-welded pipeline or the ground to drive the welding rail frame to move in an axial direction of the to-be-welded pipeline; and
a girth welding driving device configured to drive the welding device to rotate around a to-be-welded weld seam of the to-be-welded pipeline, in which one of the welding rail frame and the welding device is connected to the girth welding driving.

In some embodiments, the traveling device further includes a connecting shaft; an axial direction of the connecting shaft is perpendicular to a moving direction of the traveling device; two axial ends of the connecting shaft are respectively provided with the driving wheels; all the driving wheels of the same connecting shaft are differential driving wheels for rolling against the to-be-welded pipeline.

In some embodiments, the connecting shaft is a rotatable driving shaft; a transmission universal joint is provided between any of the differential driving wheels and the driving shaft; the driving shaft is connected in series with supporting transmission shafts of all the differential driving wheels through the transmission universal joint to form a multi-shaft joint.

In some embodiments, the traveling device further includes a controller and a positioning sensor configured to detect a position of the to-be-welded weld seam of the to-be-welded pipeline; the controller is coupled to the positioning sensor and a power device of the driving wheel for controlling the start or stop of the driving wheel according to the position of the to-be-welded weld seam.

In some embodiments, the welding container further includes a welding housing; the welding rail frame and the welding device are both arranged in the welding housing; a through chamber for the to-be-welded pipeline to pass through and an openable door arranged at an opening of the through chamber are provided in the welding housing.

In some embodiments, the through chamber is in a shape of an arched door opening; the openable door includes a first foldable windproof shelter arranged at an end opening of the through chamber; the first foldable windproof shelter is configured to shield or expose a gap between the end opening and the to-be-welded pipeline passing through the end opening.

In some embodiments, the openable door includes a second foldable windproof shelter arranged at a bottom opening of the through chamber and configured to shield or expose the bottom opening.

In some embodiments, the welding housing is provided with a windproof shelter driver; the first foldable windproof shelter and the second foldable windproof shelter are both connected to the windproof shelter driver to be automatically opened or closed.

In some embodiments, the welding housing is provided with a telescopic rod and a grounding pin; the grounding pin is coupled to the welding housing, the grounding pin is arranged at a bottom end of the telescopic rod; and the telescopic rod is configured to move in a vertical direction to insert the grounding pin into the ground.

In some embodiments, the welding rail frame includes a ring gear; the welding device includes a welding actuator cooperating with teeth of the ring gear; the girth welding driving device is connected to the welding actuator to drive the welding actuator to rotate along the ring gear.

In some embodiments, the welding actuator is provided with a welding head which is expandable and retractable along a radial direction of the ring gear.

In some embodiments, the ring gear includes at least two arc-shaped racks for surrounding and being openable and closable relative to the to-be-welded pipeline.

In some embodiments, the welding rail frame further includes a pipe clamp for surrounding and being openable and closable relative to the to-be-welded pipeline; the pipe clamp clamps the to-be-welded pipeline tightly when the pipe clamp is closed.

In some embodiments, the welding container further includes an energy console; the energy console includes a power supply device, a gas supply device and a console base; the power supply device is connected to the welding container through a cable, the gas supply device is connected to the welding container through a gas pipeline; and the power supply device and the gas supply device are integrated into the console base.

In some embodiments, the energy console and/or the welding container is provided with a wireless communication device which is connected to a wireless manipulation terminal.

Compared with the above background technology, the welding workstation provided according to the present application includes the welding container, and the welding container includes the welding rail frame, the welding device, the traveling device and the girth welding driving device; the welding rail frame is configured to surround along the circumferential direction of the to-be-welded pipeline, so as to provide a positioning and mounting foundation for the welding device, in other words, the welding device is arranged on the welding rail frame; the traveling device is connected to the welding rail frame, and the traveling device includes the driving wheel for rolling against the to-be-welded pipeline or the ground, and the driving wheel can drive the welding rail frame to move along the axial direction of the to-be-welded pipeline, so as to adjust a specific position of the welding device along the axial direction of the to-be-welded pipeline; the girth welding driving device is connected to one of the welding rail frame and the welding device, and can drive the welding device to rotate around the to-be-welded weld seam of the to-be-welded pipeline, so as to adjust the specific position of the welding device along the circumferential direction of the to-be-welded pipeline.

The welding workstation provided according to the present application can realize automatic traveling and automatic welding after being clamped to the to-be-welded pipeline at one time, and thus can conveniently, quickly and accurately complete the welding operations of different stations after being clamped at one time.

It can be seen that the manual welding is replaced by the automatic welding in the welding workstation, which reduces the residence time of the operator in the welding site, avoids the damage caused by additional products of the welding operation to the operator, and is beneficial to improving the operation environment of the operator; the fast alignment can be realize by using automatic traveling function of the traveling device, without need for the operator to manually drag and adjust the position of the welding workstation and without need to frequently clamp the welding workstation when the station is changed, which simplifies the process and improves the efficiency, and can avoid the uneven welding quality of different stations caused by repeated clamping of the welding workstation. In other words, the welding workstation provided according to this embodiment can improve the process quality and process efficiency.

### BRIEF DESCRIPTION OF THE EMBODIMENTS

To describe the technical solutions in the embodiments of the present application or in the conventional technology more clearly, the accompanying drawings required for describing the embodiments or the conventional technology are briefly introduced hereinafter. Apparently, the accompanying drawings in the following description show merely the embodiments of the present application, and a person of ordinary skill in the art can derive other drawings from these accompanying drawings without creative efforts.

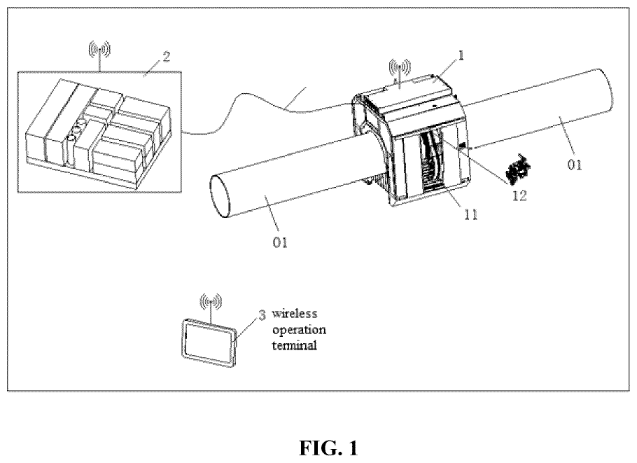

FIG. 1 is a schematic structural view of a welding workstation provided according to an embodiment of the present application;

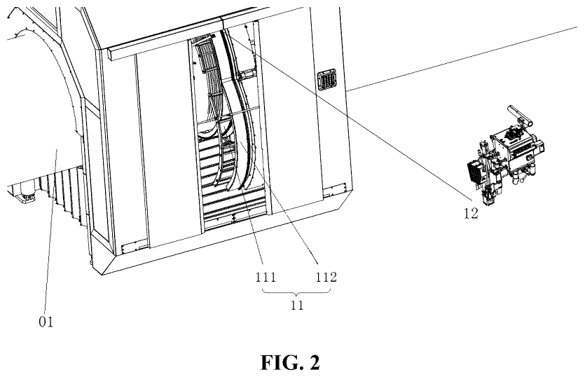

FIG. 2 is a partial enlarged view of FIG. 1;

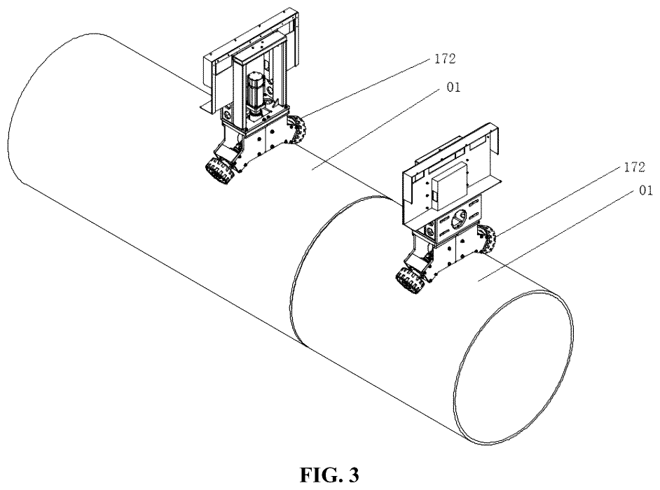

FIG. 3 is a schematic view showing an assembly of a traveling device and a to-be-welded pipeline provided according to the embodiment of the present application;

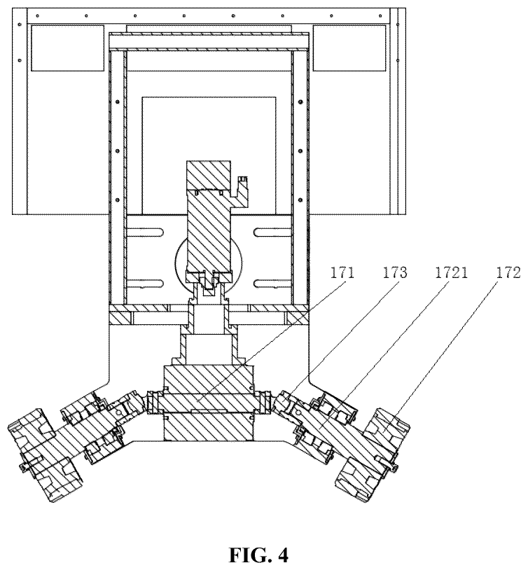

FIG. 4 is a cross-sectional view of the traveling device provided according to the embodiment of the present application;

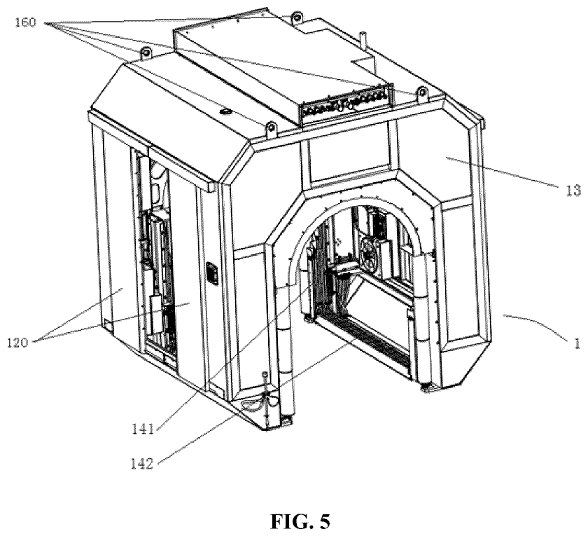

FIG. 5 is a schematic structural view of a welding container when an openable door is in an open state provided according to the embodiment of the present application;

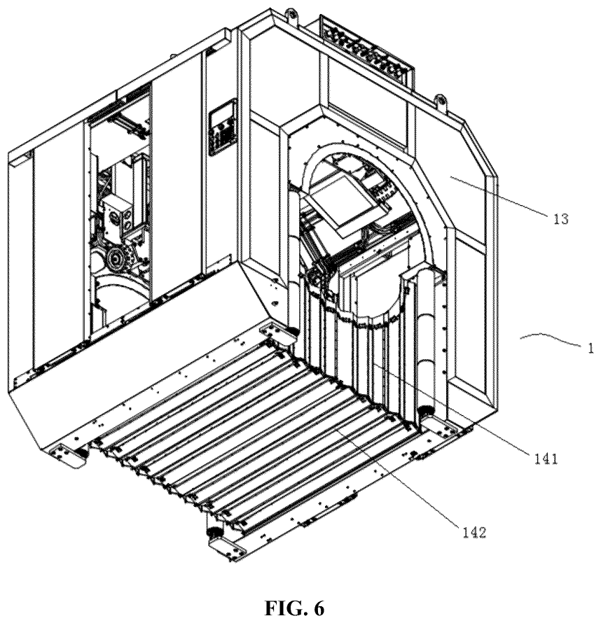

FIG. 6 is a schematic structural view of the welding container when the openable door is in a closed state provided according to the embodiment of the present application;

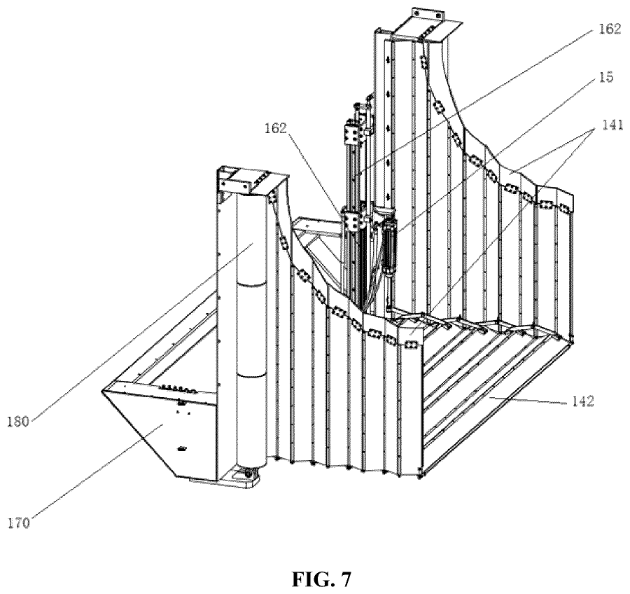

FIG. 7 is a schematic structural view of first foldable windproof shelters and a second foldable windproof provided according to the embodiment of the present application;

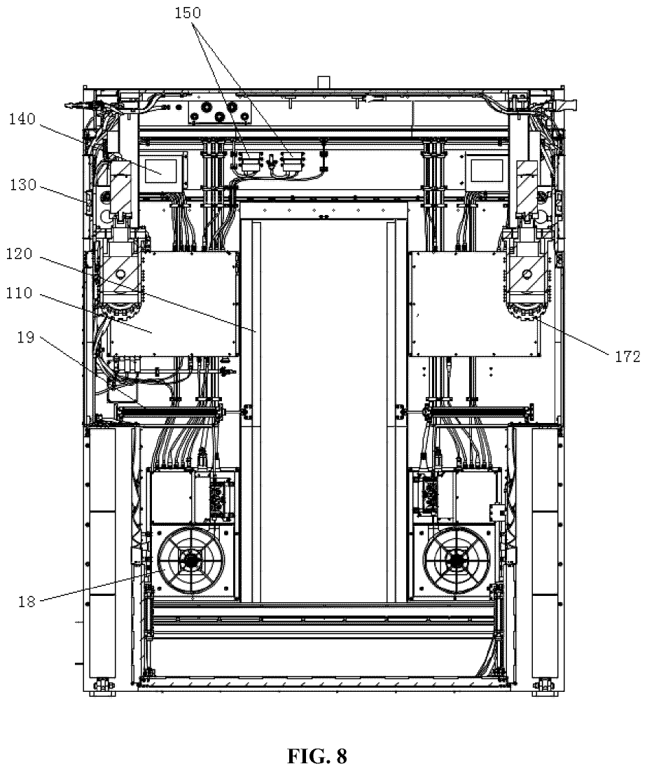

FIG. 8 is a cross-sectional view of the welding container provided according to the embodiment of the present application;

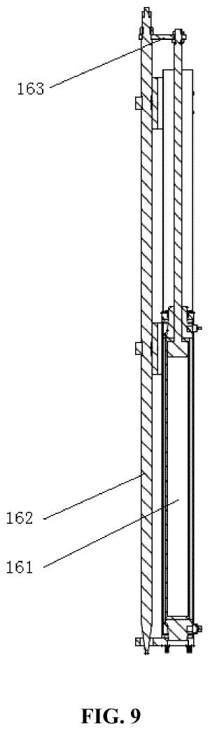

FIG. 9 is a schematic structural view of a telescopic rod and a grounding pin provided according to the embodiment of the present application;

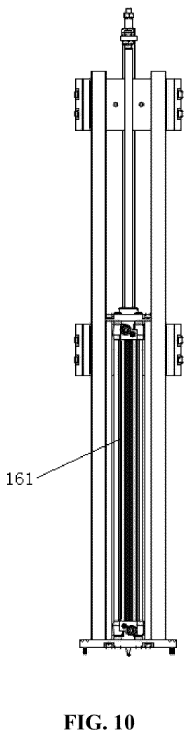

FIG. 10 is a right view of the telescopic rod and the grounding pin in FIG. 9;

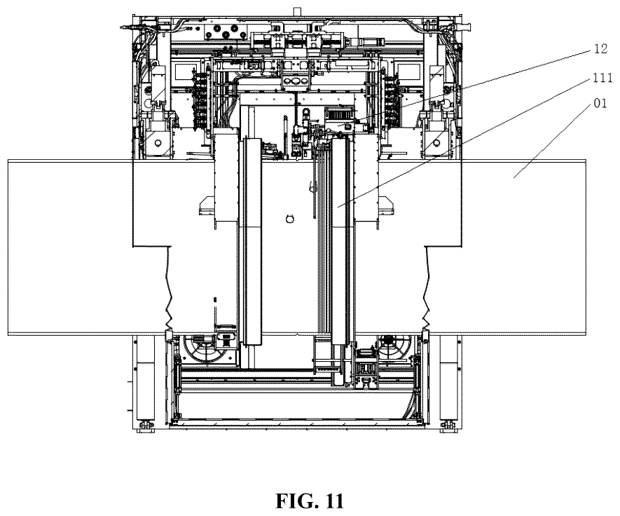

FIG. 11 is a cross-sectional view of the welding container and the to-be-welded pipeline in a first aspect provided according to the embodiment of the present application;

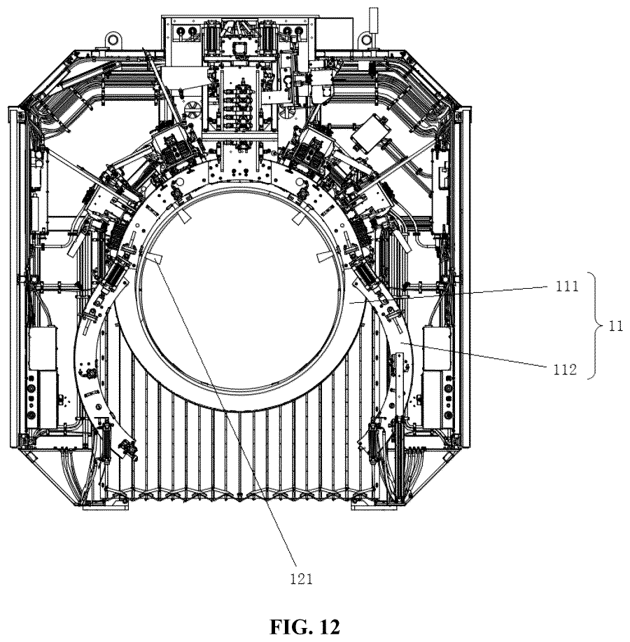

FIG. 12 is a cross-sectional view of the welding container and the to-be-welded pipeline in a second first aspect provided according to the embodiment of the present application; and

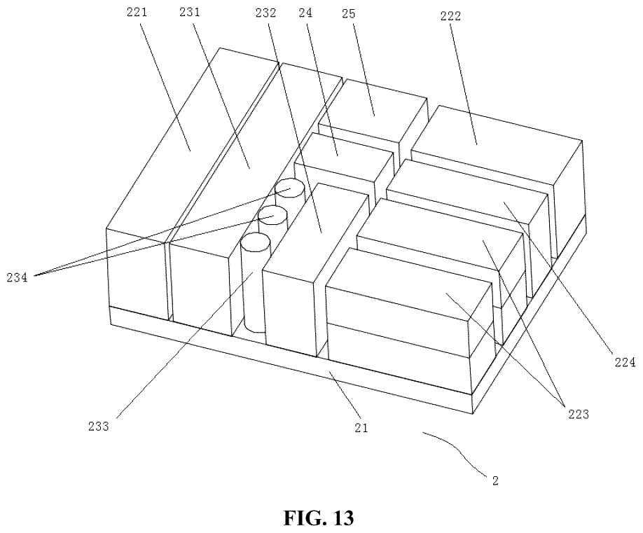

FIG. 13 is a schematic structural view of an energy console provided according to the embodiment of the present application.

Reference numerals are as follows:

| | |
|---|---|
| 01, to-be-welded pipeline; | 1, welding container; |
| 11, welding rail frame; | 111, ring gear; |
| 112, pipe clamp; | 12, welding device; |
| 121, welding head; | 13, welding housing; |
| 141, first foldable windproof shelter; | 142, second foldable windproof |
| | shelter; |
| 15, windproof shelter driver; | 161, telescopic rod; |
| 162, grounding pin; | 171, driving shaft; |
| 172, driving wheel; | 1721, supporting transmission |
| | shaft; |
| 173, transmission universal joint; | 18, wire feeder; |
| 19, operation door driver; | 110, control box; |
| 120, operation door; | 130, exhaust device; |
| 140, lighting panel lamp; | 150, temperature and humidity |
| | collector; |
| 160, lifting lug; | 170, supporting foot; |
| 180, roller; | 2, energy console; |
| 21, console base; | 221, power station; |
| 222, intermediate frequency heating | 223, welding power supply; |
| power supply; | |
| 224, argon arc welding power supply; | 231, air compressor; |
| 232, proportioner; | 233, carbon dioxide cylinder; |
| 234, argon cylinder; | 24, control device; |
| 25, base station; | 3, wireless manipulation terminal. |

### DETAINED DESCRIPTION OF THE EMBODIMENTS

Technical solutions in the embodiments of the present application are clearly and completely described below in conjunction with the drawings of the embodiments of the present application. Apparently, the embodiments described in the following are only some embodiments of the present application, rather than all of the embodiments. Any other embodiments obtained by those skilled in the art based on the embodiments in the present application without any creative work fall in the protection scope of the present application.

In order to make the person skilled in the art have a better understanding of solutions of the present application, the present application is described in further detail hereinafter, in conjunction with the drawings and embodiments.

Referring to FIGS. 1 to 13, FIG. 1 is a schematic structural view of a welding workstation provided according to an embodiment of the present application; FIG. 2 is a partial enlarged view of FIG. 1; FIG. 3 is a schematic view showing an assembly of a traveling device and a to-be-welded pipeline provided according to the embodiment of the present application; FIG. 4 is a cross-sectional view of the traveling device provided according to the embodiment of the present application; FIG. 5 is a schematic structural view of a welding container when an openable door is in an open state provided according to the embodiment of the present application; FIG. 6 is a schematic structural view of the welding container when the openable door is in a closed state provided according to the embodiment of the present application; FIG. 7 is a schematic structural view of first foldable windproof shelters and a second foldable windproof provided according to the embodiment of the present application; FIG. 8 is a cross-sectional view of the welding container provided according to the embodiment of the present application; FIG. 9 is a schematic structural view of a telescopic rod and a grounding pin provided according to the embodiment of the present application; FIG. 10 is a right view of FIG. 9; FIG. 11 is a cross-sectional view of the welding container and the to-be-welded pipeline in a first aspect provided according to the embodiment of the present application; FIG. 12 is a cross-sectional view of the welding container and the to-be-welded pipeline in a second first aspect provided according to the embodiment of the present application; and FIG. 13 is a schematic structural view of an energy console provided according to the embodiment of the present application.

A welding workstation is provided according to the present application, which can refer to FIG. 1 and FIG. 2 and includes a welding container 1 for being clamped to a to-be-welded pipeline 01, so as to realize the welding operation; the welding container 1 includes a welding rail frame 11, a welding device 12, a traveling device and a girth welding driving device; the welding rail frame 11 is configured to surround along a circumferential direction of the to-be-welded pipeline 01 so as to realize the positioning and mounting of the welding container 1 relative to the to-be-welded pipeline 01; the welding device 12 is arranged on the welding rail frame 11 and realizes welding by using a welding material to weld the to-be-welded pipeline 01, for example, weld seam welding is performed on adjacent axial ends of two coaxially spliced to-be-welded pipelines 01; the traveling device is connected to the welding rail frame 11, the traveling device includes a driving wheel for rolling against the to-be-welded pipeline 01 or the ground to drive the welding rail frame 11 to move along an axial direction of the to-be-welded pipeline 01, so as to adjust specific positions of the welding rail frame 11 and the welding device 12 along the axial direction of the to-be-welded pipeline 01; the girth welding driving device is connected to the welding rail frame 11 or the welding device 12, which drives the welding device 12 to rotate around a to-be-welded weld seam of the to-be-welded pipeline 01, so as to assist the welding device to complete the weld seam welding operation. Certainly, the welding device 12 can also realize other welding operations other than weld seam welding operation based on the motion characteristics of the welding device 12.

In this embodiment, the welding rail frame 11 may be a circular ring. The welding rail frame 11 surrounds along the circumferential direction of the to-be-welded pipeline 01, which provides the foundation for the positioning and mounting of the welding device 12 outside the to-be-welded pipeline 01, and further provides a motion foundation for the welding device 12 to rotate around the to-be-welded pipeline 01 so as to realize girth welding.

The girth welding driving device drives the welding rail frame 11 to rotate when the girth welding driving device is connected to the welding rail frame 11, the welding device 12 can be relatively fixed to the welding rail frame 11, and the welding rail frame 11 and the welding device 12 rotate synchronously around the to-be-welded pipeline 01 driven by the girth welding driving device. The welding rail frame 11 is used as a track by the welding device 12 for realizing the rotational motion when the girth welding driving device is connected to the welding device 12, and the welding device 12 rotates along the welding rail frame 11 driven by the girth welding driving device.

In addition to the welding material and the energy for heating the welding material, a welding shielding gas is generally required when the welding device 12 performs the welding operation. Therefore, in the welding workstation provided according to the present application, the welding container 1 may be provided with a gas supply assembly for providing the welding shielding gas.

The welding operation of the to-be-welded pipeline 01 generally refers to the pipeline girth welding of two coaxial to-be-welded pipelines 01 through adjacent ends, so that the two to-be-welded pipelines 01 are fixedly connected as a whole. As described above, the welding workstation may be used in other welding operations of the to-be-welded pipeline 01, such as bottom welding, filling welding and covering welding from an outer side of the pipeline that has undergone internal root welding. In addition, repair welding can be performed on a partial pipe wall of a certain to-be-welded pipeline 01.

For each welding operation requirement of the to-be-welded pipeline 01, it can be known form the above description that, in this embodiment, the girth welding driving device can directly drive the welding device 12 or indirectly drive the welding device 12 through the welding rail frame 11 to rotate along the circumferential direction of the to-be-welded pipeline 01, and the traveling device and the driving wheel thereof indirectly drive the welding device 12 through the welding rail frame 11 to move along the axial direction of the welding device 12, thereby adjusting the specific positions of the welding rail frame 11 and the welding device 12 in the axial direction of the to-be-welded pipeline 01, so as to realize the automatic traveling along the axial direction of the pipeline.

In addition to adjusting the welding station of the welding device 12 by means of the automatic traveling function of the traveling device, the welding workstation can adjust the welding station of the welding device 12 by using the conventional hoisting operation. The hoisting operation can be understood as using hoisting machinery to pull the welding container 1 and the welding device 12 to move along the axial direction of the to-be-welded pipeline 01.

It can be seen that after the welding workstation provided according to the present application is clamped to the to-be-welded pipeline 01 at one time, on one hand, the welding device 12 can realize an automatic welding without manual manipulation by the operator, which reduces the residence time of the operator in the welding site and improves the operation environment of the operator; on the other hand, the welding device 12 can realize welding at different positions of the to-be-welded pipeline 01, without need for the operator to manually adjust the position of the welding workstation and without need to frequently clamp the welding workstation and multiple members when the station is changed, which simplifies the process and improves the efficiency, and avoids the uneven welding quality of different stations caused by repeated clamping of the welding workstation. In other words, the welding workstation provided according to this embodiment can improve the process quality and process efficiency.

The welding workstation provided according to the application is further described below in combination with the accompanying drawings and embodiments.

Referring to FIG. 3, in some embodiments, the traveling device of the welding workstation further includes a connecting shaft; an axial direction of the connecting shaft is perpendicular to a moving direction of the traveling device. Since the traveling device moves along the axial direction of the to-be-welded pipeline 01, the axial direction of the connecting shaft is also perpendicular to the axial direction of the to-be-welded pipeline 01. Two axial ends of the connecting shaft are respectively provided with multiple driving wheels 172, and all the driving wheels 172 mounted on the same connecting shaft are differential driving wheels for rolling against the to-be-welded pipeline 01.

Two differential driving wheels of the same connecting shaft can be driven by power device to realize differential motion, or wheels with differential motion characteristics, such as mecanum wheel, can be used as the above differential driving wheels to meet the differential motion characteristics of the traveling device, or a differential transmission mechanism may be provided between the connecting shaft and any differential driving wheel to meet the differential motion characteristics of the traveling device.

Referring to FIG. 3 and FIG. 4, for example, the connecting shaft is specifically arranged as a rotatable driving shaft 171; each driving wheel 172 may include a supporting transmission shaft 1721 and a wheel body arranged on the supporting transmission shaft 1721; meanwhile, a transmission universal joint 173 is provided between the driving shaft 171 and any driving wheel 172 connected thereto.

In the above example, the transmission universal joint 173 is arranged between the driving shaft 171 and the supporting transmission shaft 1721 of any driving wheel 172. On one hand, the transmission universal joint 173 can transmit a force between the driving shaft 171 and the supporting transmission shaft 1721, so that the driving shaft 171 in a rotating state can transmit torque to the driving wheels 172 at the axial two ends of the driving shaft 171, to drive the driving wheels 172 at the two axial ends of the driving shaft 171 to rotate synchronously, so that the driving wheels 172 roll along the axial direction of the to-be-welded pipeline 01; on the other hand, the transmission universal joint 173 can hinge the driving shaft 171 to the supporting transmission shaft 1721 of the driving wheel 172, so that the driving shaft 171 is connected in series with the two supporting transmission shafts 1721 at the axial two ends of the driving shaft 171 to form a multi-shaft joint, and an included angle between the interconnected driving shaft 171 and the supporting transmission shaft 1721 is adjustable to provide a guarantee for the differential motion of the two driving wheels 172 at the two axial ends of the same drive shaft 171, and the drive wheel 172 can roll against a straight pipe section and a curved pipe section of the to-be-welded pipeline 01.

Referring to FIGS. 1 to 4, the traveling device is erected on an upper pipe wall of the to-be-welded pipeline 01 when the welding container 1 is clamped to the to-be-welded pipeline 01. In addition, one welding container 1 is respectively provided with two traveling devices along the axial direction of the to-be-welded pipeline 01; the driving shaft 171 of any traveling device is driven by a servo motor, and the welding container 1 can realize the automatic traveling back and force along the axial direction of the to-be-welded pipeline 01 driven by the servo motor. Apparently, a power device of the drive wheels 172 when the driving shaft 171 drives the drive wheel 172 to rotate is also the power device of the driving shaft 171, such as the above servo motor.

It can be known form the previous description that, the welding container 1 of the welding workstation can replace the welding station by using the automatic traveling function of the traveling device, or replace the welding station by using the traction of the hoisting machinery or artificial traction to drive the welding container 1 to move along the axial direction of the to-be-welded pipeline 01. Compared with the latter, the automatic traveling of the welding container 1 driven by the traveling device is relatively time-saving and labor-saving, and the operation is reliable and safe. On this basis, in order to further improve the moving accuracy of the traveling device when the welding station is replaced, the traveling device further includes a controller and a positioning sensor configured to detect a position of the to-be-welded weld seam, and the controller is coupled to the positioning sensor and the power device of the driving wheel 172. Therefore, signal transmission can be realized between the positioning sensor and the controller, and the signal transmission can also be realized between the controller and the power device of the driving wheel 172.

The signal including the position of the to-be-welded weld seam collected by the positioning sensor is transmitted to the controller, and the controller transmits the signal for controlling a rotational speed of the driving wheels 172 to the power device of the driving wheels 172 according to the position of the to-be-welded weld seam, to control the driving wheels 172 to start or stop, control the traveling device automatically to travel to a target weld seam along the to-be-welded pipeline 01, and control the welding rail frame 11 and the welding device 12 arranged on the welding rail frame 11 to be just aligned with the target weld seam.

For example, the positioning sensor can collect a first weld seam signal if the welding rail frame 11 and the welding device 12 arranged on the welding rail frame 11 are not aimed at the target weld seam; and the positioning sensor can collect a second weld seam signal if the welding rail frame 11 and the welding device 12 arranged on the welding rail frame 11 are aimed at the target weld seam. The signal transmission is realized between the positioning sensor and the controller, the controller controls the driving wheel 172 to continue to rotate in a case that the controller obtains the first weld seam signal of the positioning sensor, control the traveling device continue to travel along the axial direction of the to-be-welded pipeline 01; the controller controls the driving wheel 172 to stop rotating, the traveling devices stops, and the welding rail frame 11 and the welding device 12 arranged on the welding rail frame 11 stay at current positions in a case that the controller obtains the second weld seam signal of the positioning sensor, so that the welding rail frame 11 and the welding device 12 arranged on the welding rail frame 11 are aligned with the target weld seam. In addition, if the first weld seam signal is collected again within a preset collection period after the controller controls the driving wheel 172 to stop rotating based on the second weld seam signal, it means that the welding container 1 and the welding device 12 have crossed the target weld seam for some reason. At this time, the controller can control the driving wheel 172 to rotate reversely, control the traveling device to travel backward, and control the welding container 1 and the welding device 12 to be re-aimed at the target weld seam.

The above merely takes the weld seam welding operation as an example for description. The positioning sensor can take a target welding position as a detection object to realize the detection when other welding operation is performed by the welding workstation provided according to the present application. Accordingly, the controller automatically drives the traveling device to travel based on whether the welding device 12 is aimed at the target welding position.

In addition to the positioning sensor, the welding container 1 may be provided with an image acquisition device such as a camera. The image acquisition device can cooperate with the positioning sensor to collect the position of the to-be-welded weld seam, and can scan a to-be-welded area of the to-be-welded pipeline 01, which is convenient for the welding device to perform the welding operation.

Referring to FIG. 1, FIG. 2 and FIGS. 5 to 8, in some embodiments, the welding container 1 further includes a through chamber and a welding housing 13 with an openable door; and the welding rail frame 11 and the welding device 12 of the welding container 1 are arranged inside the welding housing 13.

The welding housing 13 is defined with the through chamber for the to-be-welded pipeline 01 to pass through, so that the to-be-welded pipeline 01 passes through the through chamber when the welding container 1 is clamped to the to-be-welded pipeline 01, in other words, the welding housing 13 is clamped to the to-be-welded pipeline 01. The welding rail frame 11 and the welding device 12 are arranged inside the welding housing 13, that is, located between the welding housing 13 and the to-be-welded pipeline 01. It can be seen that the welding housing 13 provides a relatively closed operation space for the welding rail frame 11 and the welding device 12, which is not only beneficial to providing an independent and suitable welding environment for the welding operation of the welding device 12, but also avoiding the random diffusion of various additional products during the welding process in the welding site.

The welding housing 13 may be provided with an exhaust device 130 when the welding housing 13 is used to surround the welding rail frame 11 and the welding device 12, the gaseous or dusty additional products produced in the welding operation can be extracted by the exhaust device 130, and the additional products can be treated harmlessly by the exhaust device 130.

Since the through chamber is defined inside the welding housing 13, an outer surface of the welding housing 13 is not a complete and continuous closed housing surface. For example, in order to clamp the circular to-be-welded pipeline, the through chamber may be a circular-hole chamber extending through the welding housing 13. Accordingly, at least two circular openings may be defined on the outer surface of the welding housing 13, and the two circular openings are respectively defined on two opposite surfaces of the welding housing 13. In addition, considering that the welding container 1 of the welding workstation generally needs to be hoisted to the to-be-welded pipeline 01 by the hoisting machinery, the through chamber may be in the shape of an arched door opening, which is convenient for the through chamber to be aligned with and clamp the to-be-welded pipeline 01. Besides, the welding housing 13 with the through chamber is in a shape of an inverted U-shaped housing, at least three surfaces of the welding housing 13 have openings, and the openings of the three surfaces are connected in sequence.

It can be seen from the above that the welding housing 13 is configured to provide a relatively closed operation space for the welding rail frame 11 and the welding device 12, which realizes wind and rain protection for multiple members in the welding container 1, especially realizes wind protection when the welding device 12 performs the welding operation. Since the welding housing 13 forms an opening by defining the through hole, the openable door may be provided at the opening to meet different needs of the welding container 1 and the welding housing 13 before and after welding and during welding operation.

Before welding, the openable door is open to expose the opening of the welding housing 13 when the welding container 1 and the welding housing 13 need to be clamped to the to-be-welded pipeline 01, so that the to-be-welded pipeline 01 enters the welding housing 13 from the opening of the welding housing 13. After welding, the openable door is open to perform related operation when the welding container 1 and the welding housing 13 need to be removed from the to-be-welded pipeline 01. During welding, the openable door is in the closed state, so that a relatively closed space is formed between the to-be-welded pipeline 01 and the welding housing 13.

On the basis of the welding housing 13 in the shape of the inverted U-shaped housing, in order to reduce the burden of the operator and ensure the personal safety of the operator, the openable door of the welding housing 13 can include first foldable windproof shelters 141 arranged at end openings of two axial ends of the through hole, that is, the welding housing 13 includes two end openings which are located on the two axial ends of the welding housing 13 and the through chamber; the two foldable windproof shelters 141 are respectively arranged at the two end openings for partially closing the end openings when unfolded and fully exposing the end openings when folded.

Since the to-be-welded pipeline 01 needs to pass through the welding housing 13 from the two end openings, the first foldable windproof shelter 141 cannot completely close the end opening for any one end opening and needs to expose and merely expose a partial area (which can be regarded as an area A) for the to-be-welded pipeline 01 to pass through. Conversely, the foldable windproof shelter 141 is configured to shield or expose a gap (which can be regarded as an area B) between the end opening and the to-be-welded pipeline 01 passing through the end opening. Apparently, an end opening is exactly the sum of the area A and the area B.

It can be seen that, the first foldable windproof shelter 141 shields the gap between the end opening and the to-be-welded pipeline 01 passing through the end opening when the first foldable windproof shelter 141 is unfolded; and the first foldable windproof shelter 141 exposes the gap between the end opening and the to-be-welded pipeline 01 passing through the end opening when the e first foldable windproof shelter 141 is folded.

When the welding housing 13 is in the shape of the inverted U-shaped housing, the welding housing 13 includes the two end openings, and further includes a bottom opening; accordingly, the openable door of the welding housing 13 further includes a second foldable windproof shelter 142 arranged at the bottom opening of the through chamber and configured to shield or expose the bottom opening. The second foldable windproof shelter 142 is arranged at the bottom opening of the through chamber, the second foldable windproof shelter 142 completely closes the bottom opening when the second foldable windproof shelter 142 is unfolded; and the second foldable windproof shelter 142 completely exposes the bottom opening when the second foldable windproof shelter 142 is folded.

In addition, the welding housing 13 is further provided with a windproof shelter driver 15; the first foldable windproof shelter 141 and the second foldable windproof shelter 142 are both connected to the windproof shelter driver 15, and the windproof shelter driver 15 can drive the first foldable windproof shelter 141 and the second foldable windproof shelter 142 to open or close automatically.

The first foldable windproof shelter 141 and the second foldable windproof shelter 142 are respectively connected to the windproof shelter driver 15, so that the two windproof shelter drivers 15 respectively drive the first foldable windproof shelter 141 and the second foldable windproof shelter 142 to open or close automatically, or the first foldable windproof shelter 141 is connected to the second foldable windproof shelter 142 to realize synchronous movement, so that one windproof shelter driver 15 can be used to drive the first foldable windproof shelter 141 and the second foldable windproof shelter 142 to fold or unfold synchronously.

The windproof shelter driver 15 drives both the first foldable windproof shelter 141 and the second foldable windproof shelter 142 to automatically fold and converge when the welding container 1 is hoisted to the to-be-welded pipeline 01 or is hoisted separated from the to-be-welded pipeline 01, so as to facilitate the mounting and disassembly of the welding container 1 relative to the to-be-welded pipeline 01; the windproof shelter driver 15 drives both the first foldable windproof shelter 141 and the second foldable windproof shelter 142 to automatically fold and converge when the welding container 1 travels along the to-be-welded pipeline 01, so as to facilitate the traveling of the welding container 1; the windproof shelter driver 15 drives both the first foldable windproof shelter 141 and the second foldable windproof shelter 142 to automatically unfold and close when the welding container 1 performs the welding operation, so that the welding container 1 forms a relatively closed box housing on a periphery of the to-be-welded pipeline 01 for windproof. The automatic folding and convergence of the first foldable windproof shelter 141 and the second foldable windproof shelter 142 means that the first foldable windproof shelter 141 and the second foldable windproof shelter 142 are automatically opened to expose the openings of the welding housing 13; the automatic unfolding of the first foldable windproof shelter 141 and the second foldable windproof shelter 142 means that the first foldable windproof shelter 141 and the second foldable windproof shelter 142 are automatically closed to shield the openings of the welding housing 13.

The first foldable windproof shelter 141 connected to the windproof shelter driver 15 is taken as an example, and the windproof shelter driver 15 may be a piston cylinder such as an electric cylinder or an air cylinder. A cylinder body of the piston cylinder is mounted on one side of the first foldable windproof shelter 141 along a folding direction, and a piston rod of the piston cylinder is connected to another side of the first folding windproof shed 141 along the folding direction. Therefore, the first foldable windproof shelter 141 alternates between the folded state and the unfolded state with the telescopic movement of the piston rod of the piston cylinder.

The first foldable windproof shelter 141 is still taken as an example for the specific structures of the first foldable windproof shelter 141 and the second foldable windproof shelter 142. The first foldable windproof shelter 141 may include multiple foldable plates, and all the foldable plates are connected in sequence into one through movable hinges.

Generally, the first foldable windproof shelter 141 and the second foldable windproof shelter 142 are made of materials with relatively high rigidity such as metal, so that the actual sealing effect of the first foldable windproof shelter 141 and the second foldable windproof shelter 142 for the to-be-welded pipeline 01 is difficult to meet the design expectation. For example, a gap is generally present between the first foldable windproof shelter 141 and the to-be-welded pipeline 01 when the first foldable windproof shelter 141 in the unfolded state closes the to-be-welded pipeline 01. Therefore, in addition to providing the first foldable windproof shelter 141 and the second foldable windproof shelter 142, the welding container 1 may be provided with a flexible windproof curtain at any end opening, which is used to shield the gap between the first foldable windproof shelter 141 and the to-be-welded pipeline 01. Compared with the first foldable windproof shelter 141, the flexible windproof curtain may be dragged and stacked on the surface of the to-be-welded pipeline 01, so as to completely seal the space between the to-be-welded pipeline 01 and the welding housing 13, which has little effect on the movement of the welding container 1 along the axial direction of the to-be-welded pipeline 01.

In addition to the first foldable windproof shelter 141 and the second foldable windproof shelter 142 as the openable door, the welding container 1 may further includes an operation door 120 and an operation door driver 19 which are arranged on the welding housing 13, the operation door 120 is generally arranged on a side surface of the welding housing 13 and can be used as a passage for the operator to enter or exit the welding housing 13; the operation door driver 19 is connected to the operation door 120, and is configured to drive the operation door 120 to open or close. The operator can enter the welding housing 13 from the operation door 120 when the operation door 120 is opened, to manually manipulate, repair and replace the members in the welding housing 13. Conversely, the welding housing 13 is completely closed when the operation door 120 and the openable door are closed, which can provide a stable, reliable and closed operation environment for the automatic operation of the members in the welding container 1.

The operation doors may be mounted on a same side of the welding housing 13 in pairs, so as to form a split sliding door.

In addition, the welding container 1 may further include a lifting lug 160 arranged at a top of the welding housing 13, a manual grounding device arranged on the welding housing 13, a roller 180 arranged inside the welding housing 13 for rolling against the to-be-welded pipeline 01, a supporting foot 170 arranged at a bottom of the welding housing 13 and multiple other electrical components arranged inside the welding housing 13.

The welding housing 13 is box-shaped, so that the welding housing 13 may include a top cover and an inclined wall plate which are located at the top, and a side wall plate and an end wall plate which are located on the side surface, and the bottom of the welding housing 13, as described above, is provided with the openable door for shielding the bottom opening of the welding housing 13.

The top cover and/or the inclined wall plate is located at the top of the welding housing 13, and multiple lifting lugs 160 may be provided, which facilitates the operator hoisting the lifting lugs 160 with the hoisting machinery to pull the welding housing 13 to move relative to the to-be-welded pipeline 01. For example, the welding housing 13 is moved up and down by the hoisting machinery, so that the welding housing 13 is clamped to the to-be-welded pipeline 01 from top to bottom, or the welding housing 13 is separated from the to-be-welded pipeline 01 from bottom to top. Alternatively, the hoisting machinery can move along the axial direction of the to-be-welded pipeline 01 by moving along the welding housing 13 through the lifting lugs, so as to replace the station.

The side wall plate and the end wall plate surround the side surface of the welding housing 13. The side wall plate refers to a plate surface of the welding housing 13 located on two radial sides of the to-be-welded pipeline 01, and the end wall plate refers to a plate surface of the welding housing 13 located on two axial ends of the to-be-welded pipeline 01. Apparently, the to-be-welded pipeline 01 extends through the welding housing 13 from the end wall plate of the welding housing 13 when the welding housing 13 is clamped to the to-be-welded pipeline 01, in other words, the end opening of the welding housing 13 is defined on the end wall plate. The operation door 120 is generally arranged on the side wall plate, so as to facilitate the operator to enter or exit the welding housing 13 from the two radial sides of the to-be-welded pipeline 01.

The rollers 180 are arranged inside the welding housing 13, and are generally distributed in pairs on the opposite sides of the to-be-welded pipeline 01; at least part of a roller wall of any roller 180 abuts against the to-be-welded pipeline 01, which can assist the traveling device to improve the motion accuracy and motion stability when the welding container 1 travels along the to-be-welded pipeline 01 automatically.

The supporting foot 170 is arranged at the bottom of the welding housing 13. The welding container 1 is mounted on the to-be-welded pipeline 01, and the to-be-welded pipeline 01 is separated from the ground, which does not affect the automatic traveling of the welding container 1. The supporting foot 170 can be used as a supporting base of the welding container 1 when the welding container 1 is removed from the to-be-welded pipeline 01, so as to realize the erection of the welding container 1 on the ground.

Electrical components such as a control box 110, an operation panel, a lighting panel lamp 140, a temperature and humidity collector 150, a switch, and a wire feeder 18 which is connected to a welding actuator are provided inside the welding housing 13. Some of the temperature and humidity collectors 150 may be arranged outside the welding housing 13, so as to collect environmental parameters inside and outside the welding housing 13 with other temperature and humidity collectors 150 arranged inside the welding housing 13. The number of the wire feeders 18 is the same with the number of the welding actuators arranged on the welding rail frame 11. For example, four wire feeders 18 can be arranged inside the welding housing 13 if the welding rail frame 11 is provided with four welding actuators, which are used to supply wire and gas to the four wire feeders 18 in one-to-one correspondence.

Referring to FIG. 6, FIG. 7 and FIG. 9, in some embodiments, the welding housing 13 is provided with a telescopic rod 161 and a grounding pin 162; the grounding pin 162 is coupled to the welding housing 13, which can meet the grounding requirements of the welding housing 13 and its components; in addition, the grounding pin 162 is arranged at a bottom end of the telescopic rod 161, and the telescopic rod 161 is used to move along a vertical direction.

The grounding pin 162 is inserted into the ground when the telescopic rod 161 moves downward along the vertical direction, so as to realize the grounding of the welding housing 13 and its components, ensure the power safety of the welding container 1 and reduce the interference caused by the electromagnetic environment to the welding container 1.

The grounding pin 162 is pulled out of the ground when the telescopic rod 161 moves upward along the vertical direction, so that the welding container 1 is separated from the ground surface, which is beneficial to moving the welding container 1.

The telescopic rod 161 may be a cylinder, and a push rod of the cylinder is connected to the grounding pin 162 through a connector. The cylinder drives the push rod to push out and retract under the control of an electromagnetic directional valve, so that the push rod drives the grounding pin 162 to be inserted into the ground or be separated from the ground surface.

Referring to FIG. 1, FIG. 2, FIG. 11 and FIG. 12, in the welding workstation provided according to the present application, the welding rail frame 11 includes a ring gear 111, and accordingly, the welding device 12 includes a welding actuator cooperating with teeth of the ring gear 111. In this embodiment, the girth welding driving device is connected to the welding actuator to drive the welding actuator to rotate along the ring gear 111, in other words, the ring gear 111 does not rotate, and the girth welding driving device directly drives the welding actuator to rotate along the ring gear 111, so as to realize the rotation of the welding actuator along the circumferential direction of the to-be-welded pipeline 01.

The teeth of welding actuator cooperates with the teeth of the ring gear 111, so that the ring gear 111 can accurately restrict the rotation accuracy and rotation speed of the welding actuator, realize the positioning of the welding actuator at any position in the circumferential direction of the to-be-welded pipeline 01, and ensure the welding effect.

The welding actuator is provided with a welding head 121 which is expandable and retractable along a radial direction of the ring gear 111, the welding head 121 is configured to be aimed at the target welding position, such as the target weld seam, so as to realize the welding operation.

For example, for any welding actuator, it may include a welding torch provided with the welding head 121, and include a base for mounting the welding torch and the welding head 121. The base is mounted on the ring gear 111 and cooperates with the teeth of the ring gear 111, and the welding torch and the welding head 121 are telescopically connected to the base, so that the welding head 121 of the welding actuator can realize the rotational movement along the ring gear 111, and can realize the linear feed movement along the radial direction of the ring gear 111. In addition, the base can be connected to the welding torch and the welding head 121 through a swinging mechanism, and a swinging direction of the swinging mechanism is parallel to the axial direction of the ring gear 111, that is, is parallel to the axial direction of the to-be-welded pipeline 01.

In the above embodiments, two welding actuators may be mounted on one ring gear 111. The two welding actuators of one ring gear 111 generally operate synchronously. Alternatively, the two welding actuators operate work independently. In the welding workstation provided according to the present application, the welding container 1 can be provided with two welding rail frames 11, which are spaced apart along the axial direction of the welding rail frame 11, and the four welding actuators arranged on the two welding rail frames 11 can operate synchronously or independently.

In order to facilitate the disassembly and assembly of the welding container 1 and the to-be-welded pipeline 01, the ring gear 111 can be assembled by multiple arc-shaped racks. For example, one ring gear 111 includes two arc-shaped racks for surrounding and being openable and closable relative to the to-be-welded pipeline 01, a single arc rack is semi annular, and the two arc racks surround a peripheral side of the to-be-welded pipeline 01. All the arc-shaped racks form a ring connected end to end when all the arc-shaped racks of the same ring gear 111 are closed; adjacent arc ends of different arc-shaped racks are separated from each other when all the arc racks of the same ring gear 111 are dispersed, so that a gap is formed in the circumferential direction of the ring gear 111, which is beneficial for the operator to clamp the to-be-welded pipeline 01 into the ring gear 111 from the gap. In other words, the welding container 1 and its welding rail 11 can clamp the to-be-welded pipeline 01 from the gap to meet the hoisting of the welding container 1 to the to-be-welded pipeline 01 from top to bottom.

The welding rail frame 11 may further include a pipe clamp 112 for surrounding and being openable and closable relative to the to-be-welded pipeline 01; the pipe clamp is dispersed to the periphery of the to-be-welded pipeline 01 to loosen the to-be-welded pipeline 01 when the pipe clamp 112 is opened, and the welding rail frame 11 can move along the axial direction of the to-be-welded pipeline 01; conversely, the pipe clamp 112 gathers towards the to-be-welded pipeline 01 to clamp the to-be-welded pipeline 01 when the pipe clamp 112 is closed, and the welding rail 11 is relatively fixed to the to-be-welded pipeline 01.

In particular, the pipe clamp 112 may be fixedly connected to the arc-shaped racks of the ring gear 111, so that the opening and closing of the ring gear 111 can be realized by the opening and closing of the pipe clamp 112. For example, the pipe clamp 112 includes two clamping arms, which are fixedly connected with the two arc-shaped racks of the ring gear 111. The clamping arms of the pipe clamp 112 drive the arc-shaped racks of the ring gear 111 to open when the welding container 1 is disassembled from the to-be-welded pipeline 01, so that a gap sufficient to allow the inlet and outlet of the to-be-welded pipeline 01 is formed between the two arc-shaped racks of the same ring gear 111. The clamping arms of the pipe clamp 112 open when the welding container 1 moves along the axial direction of the to-be-welded pipeline 01, and a gap with a certain size is also formed between the two arc-shaped racks of the same ring gear 111, and the pipe clamp 112 releases the to-be-welded pipeline 01, so that the welding container 1 can travel automatically along the axial direction of the to-be-welded pipeline 01 or be pulled to travel by the hoisting machinery.

Referring to FIG. 1, FIG. 2 and FIG. 13, based on the above embodiments, in addition to the welding container 1, the welding workstation provided according to the present application further includes an energy console 2.

The energy console 2 includes a power supply device, a gas supply device and a console base 21; the power supply device is connected to the welding container 1 through a cable, so as to provide electric energy to the welding container 1; the gas supply device is connected to the welding container 1 through a gas pipeline, so as to provide carbon dioxide, argon and other gases to the welding container 1. The power supply device and the gas supply device are integrated into the console base 21, and the console base 21 can be used to connect a pipe-hoist machine to realize the separation and independent drive of the console base 21 and the welding container 1. Certainly, the energy console 2 generally includes a control device 24 connected with the power supply device and the gas supply device.

The welding container 1 can travel automatically or travel under the traction of the hoisting machinery; since the energy console 2 is connected to the welding container 1 through the cable and the gas pipeline, the energy console 2 is driven by the pipe-hoist machine, so as to realize the movement of the welding container 1 and the energy console 2 along the axial direction of the to-be-welded pipeline 01, and ensure the power supply and gas supply from the energy console 2 to the welding container 1.

The power supply device of the energy console 2 includes a power station 221, an intermediate frequency heating power supply 222, a welding power supply 223, an argon arc welding power supply 224, a power source, and the like. The argon arc welding power source 224 is configured to provide electric energy for the argon arc welding operation of the welding device 12, and the welding power supply 223 provides electric energy for other welding operations of the welding device 12; the intermediate frequency heating power supply 222 and an intermediate frequency heating coil of the welding rail frame 11 provide intermediate frequency alternating current. The intermediate frequency heating coil can be arranged on the ring gear 111 of the welding rail frame 11. The ring gear 111 heats up when the intermediate frequency heating coil is supplied with the intermediate frequency alternating current, which can preheat a to-be-welded area of the to-be-welded pipeline 01; the power source is generally used to provide energy for the traveling device of the welding container 1 and the relevant control system of the welding container 1; and the power station 221 can be used to supply power to the energy console 2 and the equipment of the welding container 1 that requires power.

The gas supply device of the energy console 2 includes a gas pressure source, an air compressor 231, a proportioner 232, an argon cylinder 234, a carbon dioxide cylinder 233, and the like. The air pressure source is generally configured to provide power for a pneumatic actuator of the welding container 1, such as the cylinder; the function of the air compressor 231 is to convert electric energy into pneumatic energy, so as to supply gas to multiple pneumatic equipment of the welding container 1; the proportioner 232 is generally used to mix the carbon dioxide in the carbon dioxide cylinder 233 and the argon in the argon cylinder 234 according to a specified proportion and provide the mixed gas to the welding process as a welding protection and isolation medium.

In order to facilitate the operator operating the welding workstation, at least one of the energy console 2 and the welding container 1 is provided with a wireless communication device, so that the wireless communication device can be used to realize wireless connection with a wireless manipulation terminal 3, such as a tablet or a mobile phone. For example, the energy console 2 is provided with a base station 25, and the energy console 2 realizes wireless connection with the tablet as the wireless manipulation terminal 3 by using the base station 25. Generally, the wireless manipulation terminal 3 refers to a wireless operation tablet that can realize wireless communication with the wireless communication device. The operator can control an operation state of the energy console 2 and an operation state of the welding container 1 in other sites other than the welding site by using the wireless operation tablet. The operation state of the welding container 1 may include a motion state of the welding container 1 and a welding state of the welding container 1.

Furthermore, a control software configured to remotely control the energy console 2 and/or the welding container 1 is further mounted on the wireless manipulation terminal 3, to realize the mutual communication between the wireless manipulation terminal 3 and the energy console 2 and/or welding container 1, so that the operator can remotely control the energy console 2 and/or welding container 1 through the wireless manipulation terminal 3.

In summary, the welding workstation provided according to the present application can operate according to the following steps:
(1), causing the energy console 2 and welding container 1 in a hoisting preparation state, and hoisting the welding container 1 to the to-be-welded pipeline 01,
in which the operator can control the energy console 2 and the welding container 1 through the wireless operation terminal 3, so that the energy console 2 and the welding container 1 are in the hoisting preparation state, in the hoisting preparation state, the windproof door and the operation door of the welding container 1 are open, while the ring gear 111 and pipe clamp 112 of the welding rail frame 11 are also open, and the operator can hoist the welding container 1 by the hoisting machinery, cause the welding container 1 in the hoisting preparation state to clamp the to-be-welded pipeline 01 from top to bottom, and then close the windproof door and the operation door of the welding container 1,
when the welding workstation provided according to this present application is used to realize the weld seam connection operation of two coaxial and adjacent to-be-welded pipelines 01, completing aligning operation and root welding operation of the two to-be-welded pipelines 01 is included before this first step;
(2), causing the welding container 1 to move to a target station relative to the to-be-welded pipeline 01,
in which the target station refers to the to-be-welded position on the to-be-welded pipeline 01. The weld seam connection operation of two coaxial and adjacent to-be-welded pipelines 01 is taken as an example, and the target station refers to the direct connecting seam position at adjacent ends of the two to-be-welded pipelines 01, in specific construction operations, a pipeline line is generally formed by coaxial splicing of multiple to-be-welded pipelines 01. Therefore, there are generally multiple target stations in the pipeline line, the weld seam welding for the multiple target stations can be realized in sequence when the welding workstation is used to realize the welding operation of the pipeline line,
the operator can operate the energy console 2 and the welding container 1 through the wireless manipulation terminal 3, to cause the welding container 1 to move along the axial direction of the to-be-welded pipeline 01, which realizes the positioning of the welding container 1 at the target station, certainly, the operator can also pull the welding container 1 to move along the axial direction of the to-be-welded pipeline 01 by using the hoisting machinery, compared with the traction movement by the hoisting machinery, the motion accuracy of the automatic traveling of the welding container 1 is higher, and the power is generally large or the speed is small, therefore, in this step, firstly, the hoisting machinery can be used to pull the welding container 1 to move quickly, to cause the welding container 1 to be close to the target station and not cross the target station, and then cause the welding container 1 to travel automatically, so that the welding container 1 can accurately reach the target station;
(3), causing the welding container 1 to perform the welding operation, to complete the welding operation of the to-be-welded pipeline 01,
in which the welding workstation completes the accurate alignment with the target station after the second step. The third step is performed on this basis. The operator can control the energy console 2 and the welding container 1 through the wireless manipulation terminal 3, to cause the welding container 1 to automatically close the ring gear 111 and the pipe clamp 112, scan the to-be-welded area, such as the weld seam, plan and executes the welding action, complete the welding operation of the to-be-welded pipeline 01, and realize the filling and covering of the to-be-welded area.

In the third step, abnormal welding is sometimes caused by reasons such as insufficient welding wire.

If the operator detects an abnormality through various sensors and cameras inside and outside the welding container 1, the wireless manipulation terminal 3 can automatically prompt and control the welding container 1 to enter the abnormal treatment state. For example, the wireless manipulation terminal 3 can shut down the welding container 1 and open the windproof door and operation door of the welding container 1 to facilitate the operator to enter the welding container 1, and the operator can detect and deal with the abnormality of the welding container 1.

If there is no abnormality for the welding operation of the same target welding station, the welding container 1 automatically completes one welding operation, and circulates to the second step and the third step after this welding operation is completed, so as to realize the automatic welding of all target stations of the same pipeline line.

In summary, the welding workstation provided according to the present application integrates multiple devices such as the welding rail frame 11, the welding device 12, the traveling device, the girth welding driving device and the openable door inside the welding housing 13 of the welding container 1. Under the manipulation of the energy console 2 and the wireless operation terminal 3, the welding container 1 can be used as a highly integrated automatic equipment to realize a number of specific operations such as mounting, disassembly, movement and welding, that is, the welding workstation can integrate multiple processes that were originally separated from each other into one welding task that can be executed automatically.

When the welding workstation is used to perform the welding operation of the to-be-welded pipeline 01, the welding workstation can realize automatic traveling, automatic alignment and automatic welding; the operator can operate remotely and wirelessly without manual switching of processes and without entering an interior of the welding container 1, which reduces the physical and mental burden, labor intensity and operation level requirements for the operator, ensures the continuity between different processes, and greatly improves the operation efficiency and welding quality.

The automatic-traveled welding workstation has been described in detailed above. Principles and embodiments of the present application are described herein through specific examples. Description of the above embodiments is merely used to facilitate understanding the method and concept of the present application. It should be noted that several improvements and modifications can be made to the present application by those skilled in the art without departing from the principles of the present application. These improvements and modifications shall fall within the scope of the claims of the present application.

What is claimed is:

1. A welding workstation, comprising a welding container, wherein the welding container comprises:
a welding rail frame configured to surround along a circumferential direction of a to-be-welded pipeline;
a welding device arranged on the welding rail frame;
a traveling device connected to the welding rail frame, wherein the traveling device comprises a driving wheel for rolling against the to-be-welded pipeline or the ground to drive the welding rail frame to move along an axial direction of the to-be-welded pipeline; and
a girth welding driving device configured to drive the welding device to rotate around a to-be-welded weld seam of the to-be-welded pipeline, wherein one of the welding rail frame and the welding device is connected to the girth welding driving.

2. The welding workstation according to claim 1, wherein the traveling device further comprises a connecting shaft; an axial direction of the connecting shaft is perpendicular to a moving direction of the traveling device; two axial ends of the connecting shaft are respectively provided with a plurality of driving wheels; all the driving wheels of the same connecting shaft are differential driving wheels for rolling against the to-be-welded pipeline.

3. The welding workstation according to claim 2, wherein the connecting shaft is a rotatable driving shaft; a transmission universal joint is provided between any of the differential driving wheels and the driving shaft; the driving shaft is connected in series with supporting transmission shafts of all the differential driving wheels through the transmission universal joint to form a multi-shaft joint.

4. The welding workstation according to claim 1, wherein the traveling device further comprises a controller and a positioning sensor for detecting a position of the to-be-welded weld seam of the to-be-welded pipeline; the controller is coupled to the positioning sensor and a power device of the driving wheel, and is configured to control the driving wheel to start or stop according to the position of the to-be-welded weld seam.

5. The welding workstation according to claim 1, wherein the welding container further comprises a welding housing; the welding rail frame and the welding device are arranged in the welding housing; a through chamber for the to-be-welded pipeline to pass through and an openable door arranged at an opening of the through chamber are provided in the welding housing.

6. The welding workstation according to claim 5, wherein the through chamber is in a shape of an arched door opening; the openable door comprises a first foldable windproof shelter arranged at an end opening of the through chamber; the first foldable windproof shelter is configured to shield or expose a gap between the end opening and the to-be-welded pipeline passing through the end opening.

7. The welding workstation according to claim 6, wherein the openable door further comprises a second foldable windproof shelter arranged at a bottom opening of the through chamber and configured to shield or expose the bottom opening.

8. The welding workstation according to claim 7, wherein the welding housing is provided with a windproof shelter driver; the first foldable windproof shelter and the second foldable windproof shelter are both connected to the windproof shelter driver to be automatically opened or closed.

9. The welding workstation according to claim 5, wherein the welding housing is provided with a telescopic rod and a grounding pin; the grounding pin is coupled to the welding housing, the grounding pin is arranged at a bottom end of the telescopic rod; the telescopic rod is configured to move in a vertical direction to insert the grounding pin into the ground.

10. The welding workstation according to claim 1, wherein the welding rail frame comprises a ring gear; the welding device comprises a welding actuator cooperating with teeth of the ring gear; the girth welding driving device is connected to the welding actuator to drive the welding actuator to rotate along the ring gear.

11. The welding workstation according to claim 10, wherein the welding actuator is provided with a welding head which is expandable and retractable along a radial direction of the ring gear.

12. The welding workstation according to claim 10, wherein the ring gear comprises at least two arc-shaped racks for surrounding and being openable and closable relative to the to-be-welded pipeline.

13. The welding workstation according to claim 12, wherein the welding rail frame further comprises a pipe clamp for surrounding and being openable and closable relative to the to-be-welded pipeline; and the pipe clamp clamps the to-be-welded pipeline when the pipe clamp is closed.

14. The welding workstation according to claim 1, further comprising an energy console; wherein the energy console comprises a power supply device, a gas supply device and a console base; the power supply device is connected to the welding container through a cable, the gas supply device is connected to the welding container through a gas pipeline; and the power supply device and the gas supply device are integrated into the console base.

15. The welding workstation according to claim 14, wherein the energy console and/or the welding container is provided with a wireless communication device which is connected to a wireless manipulation terminal.

16. The welding workstation according to claim 2, further comprising an energy console; wherein the energy console comprises a power supply device, a gas supply device and a console base; the power supply device is connected to the welding container through a cable, the gas supply device is connected to the welding container through a gas pipeline; and the power supply device and the gas supply device are integrated into the console base.

17. The welding workstation according to claim 3, further comprising an energy console; wherein the energy console comprises a power supply device, a gas supply device and a console base; the power supply device is connected to the welding container through a cable, the gas supply device is connected to the welding container through a gas pipeline; and the power supply device and the gas supply device are integrated into the console base.

18. The welding workstation according to claim 4, further comprising an energy console; wherein the energy console comprises a power supply device, a gas supply device and a console base; the power supply device is connected to the welding container through a cable, the gas supply device is connected to the welding container through a gas pipeline; and the power supply device and the gas supply device are integrated into the console base.

19. The welding workstation according to claim 5, further comprising an energy console; wherein the energy console comprises a power supply device, a gas supply device and a console base; the power supply device is connected to the welding container through a cable, the gas supply device is connected to the welding container through a gas pipeline; and the power supply device and the gas supply device are integrated into the console base.

20. The welding workstation according to claim 6, further comprising an energy console; wherein the energy console comprises a power supply device, a gas supply device and a console base; the power supply device is connected to the welding container through a cable, the gas supply device is connected to the welding container through a gas pipeline; and the power supply device and the gas supply device are integrated into the console base.
